(19) United States
(12) Patent Application Publication
(10) Pub. No.: US 2013/0067039 A1
(43) Pub. Date: Mar. 14, 2013

(54) SYSTEM AND METHOD OF SUGGESTING SUPPLEMENTAL CONTACT DATA TO A COMPUTING DEVICE

(71) Applicants: Matt Hartzler, Chanhassen, MN (US); Benjamin Turner, Seattle, WA (US)

(72) Inventors: Matt Hartzler, Chanhassen, MN (US); Benjamin Turner, Seattle, WA (US)

(73) Assignee: RESEARCH IN MOTION LIMITED, Waterloo, ON (CA)

(21) Appl. No.: 13/635,368

(22) PCT Filed: Sep. 13, 2011
(86) PCT No.: PCT/US11/51440

§ 371 Date: Sep. 14, 2012

(51) Int. Cl. G06F 15/16

(52) U.S. Cl. 709/219

(57) ABSTRACT

Systems and methods of suggesting supplemental data on a computing device are disclosed herein. For example, the supplemental data can be suggested contact data. A request can be sent to retrieve, from at least one remote data source, suggested contact data associated with a contact entry stored on a storage medium communicatively coupled to the computing device. A confidence level can be determined and associated with the suggested contact data. A request can be sent to display a prompt comprising the suggested contact data on a computing device. Additionally, a confirmation indicative of one of an acceptance of the suggested contact data and a rejection of the suggested contact data can be received. In one example, the confidence level associated with the contact data can be modified in response to the confirmation received.

### FIELD OF TECHNOLOGY

The present disclosure relates generally to computing devices. More specifically, the present disclosure relates to a system and method of suggesting supplemental data to be presented on a computing device.

### BACKGROUND

With the advent of more robust computing systems, advancements of computing devices are becoming more prevalent. While a proliferation of information is accessible to a user via computing devices, the information which the user can access and store on his device can become outdated without prior notification to the user. For example, when a contact moves or changes jobs, the contact's telephone information, home address, work information, and other contact information can change. To this end, if the contact does not notify a user who has the contact's information stored on his computing device, the user may not be able to further communicate with the contact. Furthermore, the task of finding particular information, updating, managing, and maintaining the accuracy of information relevant to the user, however, can be quite tedious and difficult.

### BRIEF DESCRIPTION OF THE DRAWINGS

Implementations of the present application will now be described, by way of example only, with reference to the attached Figures, wherein:

FIG. 1A is an architecture diagram of an example converged address book system in accordance with an example embodiment;

FIG. 1B is a flow chart of the example converged address book system illustrated in FIG. 1A;

FIG. 2 is a block diagram illustrating the communication between a central computing device and more than one computing device in accordance with an example embodiment;

FIG. 3 is a flow chart of a method for suggesting data performed by a computing device in accordance with an example embodiment;

FIG. 4 is another flow chart of a method of suggesting data performed by a computing device illustrating the effect of a user's approval of suggested data associated with a contact stored by the user's remote computing device in accordance with an example embodiment; and

FIG. 5 is a front view of a prompt displaying suggested data on a remote computing device in accordance with an example embodiment.

FIG. 6 is a block diagram of an example processing system capable of implementing the example apparatus and methods disclosed herein.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the implementations described herein. However, it will be understood by those of ordinary skill in the art that the implementations described herein can be practiced without these specific details. In other instances, methods, procedures and components have not been described in detail so as not to obscure the related relevant feature being described. Also, the description is not to be considered as limiting the scope of the implementations described herein.

Several definitions that apply throughout this document will now be presented. The phrase “communicatively coupled” is defined as connected, whether directly or indirectly through intervening components and is not necessarily limited to physical connections. The term “computing device” is defined as any computing device that is capable of at least accepting data, transmitting data, and executing commands and includes its own power source. For example, computing devices can include and are not limited to mobile communication devices, mobile computers, smartphones, electronic pads, electronic tablets, desktop computers, laptop computers, netbooks, network-based servers, or other computing devices capable of at least accepting data, transmitting data, and executing commands and includes its own power source.

The present disclosure relates to a system and method of suggesting data performed by a computing device. The suggested data may be derived from various published data sources such blogs, news feeds, and other online and offline data services hosted and or accessible by the service providers, for example. While the present disclosure will be described herein in relation to a non-limiting example embodiment where the system and method suggests contact data for supplementing and updating contact entries of an address book of a computing device, those of ordinary skill in the art will appreciate that the present disclosure is not limited to address book implementations. In other example embodiments, the system and method disclosed herein can be implemented in online shopping systems, a mapping system, media subscription systems, social media systems, blogging systems, or other systems in which automatic retrieval and presentation of suggested data to maintain and manage the accuracy, reliability, and currency of data stored or provided by such systems.

A system and method of suggesting data performed by a computing device can include sending suggested data from a central computing device to a remote computing device and verifying the accuracy of the suggested data. For example, the method can include sending a request to retrieve from at least one remote data source, suggested data associated with a data entry stored on a storage medium of the computing device. A confidence level can be associated with the suggested data. A request to display a prompt on a computing device including the suggested data can be made. A confirmation indicative of one of an acceptance of the suggested data and a rejection of the suggested data can be received. In response to the confirmation received, the confidence level associated with the data can be modified. As will be described in further detail below, the method of suggesting data will be described in relation to suggesting contact data to supplement and update contact entries stored by a computing device. Those of skill in the art will appreciate that the below-described embodiments are merely described for example purposes and can be implemented in other systems to suggest data relating to information other than contact entries.

In at least one example embodiment, a remote computing device can be communicatively coupled to a contact repository (also referred to herein as an address book repository), such as an address book that is stored locally on the computing device, is network-based, or is both stored locally on the computing device and is network-based. There can be a situation where a contact associated with a contact entry stored in the user's contact repository moves or changes jobs. As a result, the contact can have a new email address, a new work phone number, a new business address, a new work mobile phone number, can be associated with a new website can have other updated contact data. If the contact has relocated, the contact can have a new home phone number, a new home address, or other contact data associated with the contact's new location. When the contact has updated his contact information, the contact may not have informed the user of the remote computing device that he has changed jobs. In such a situation, the remote computing device can have outdated and incorrect contact data stored in the contact repository.

In another situation, the contact may have informed the user of the remote computing device that he has changed jobs, but the user of the remote computing device may have forgotten to update his contact repository. As a result, the contact repository will have become outdated and incorrect.

In another situation, the remote computing device can have incomplete contact data associated with a contact stored in its contact repository. For example, the remote computing device may only have the contact's work email address stored in the user's contact repository but not the contact's mobile phone or work telephone number. In such a situation, the remote computing device can have a partially incomplete contact entry.

In yet another situation, the remote computing device may not have established a subscription for updates to a contact's personal contact card. For example, the subscription of contact updates has been terminated and the remote device no longer receives updates to the contact information.

It is therefore useful to retrieve and provide suggested data with which to supplement, update, or complete contact entries of a user's contact repository to ensure that the user has accurate, verified, current, and reliable contact data.

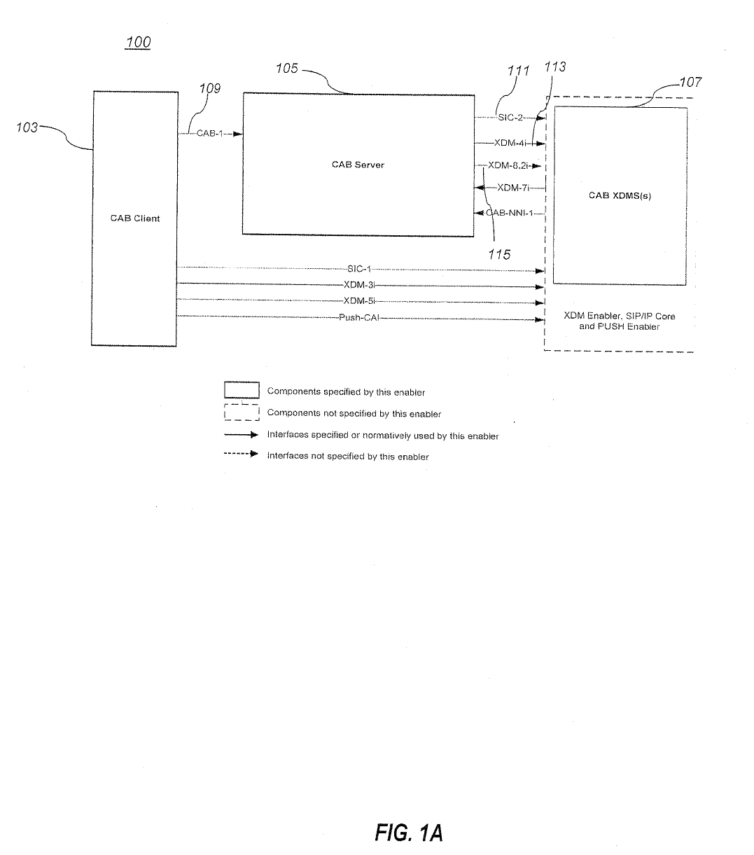

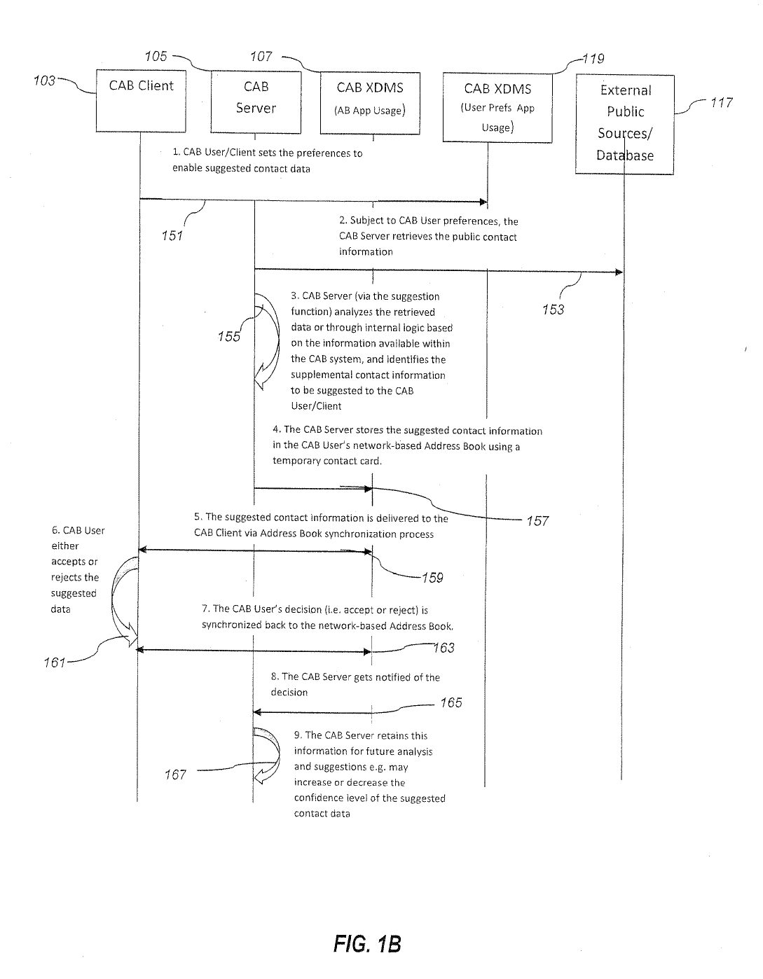

FIG. 1A is an architecture diagram of an example Converged Address Book (CAB) system whose contact data can be supplemented by the system and method described herein. The CAB illustrated in FIG. 1A provides support for developing CAB based services. The CAB can be realized using a client-server concept. For example, the CAB can interact with other network elements and can re-use concepts and technologies specified by other communication protocols. The architecture illustrated in FIG. 1A can be designed to support a wide range of computing devices independent of the access technology. The CAB system 100 can include a CAB client 103, a CAB server 105, and a CAB extensible Markup Language (XML) Document Management Server (XMDS) 107. The CAB Client 103 can be configured to synchronize modifications (for example, add, delete, modify) of a local subset of address book information (for example, contact entries which include contact data) that is contained in the network-based Address Book repository (also referred to herein as a contact repository). The CAB client 103 can also be configured to: send and receive address book related contact information, manage address book information, manage the computing device's personal contact information, receive CAB contact status information, request the import of non-CAB address book information, search for available contact information, manage CAB user preferences information, manage CAB user access permissions information, receive CAB related notifications, and manage relationship information (for example, defining relationship information with a contact, requesting or receiving a request from a contact to certify relationship information, viewing relationship information among contacts in the address book). In an example embodiment, the CAB Client 103 can be configured to receive published content about a contact and suggestions about contacts within the user's address book.

In FIG. 1A, the CAB server 105 can be configured to synchronize the address book information stored in the address book with the CAB Client(s) 103 via CAB-1 interface 109. The CAB server 105 can also be configured to manage (e.g. retrieve, create, modify, delete) address book information (which is stored in or managed by CAB XDMS 107) via an XML Document Management (XDM) Agent by using an address book application usage. In another example embodiment, the CAB server can be configured to maintain (for example, retrieve, create, modify, delete) contact status information via the XDM Agent. In at least one example embodiment, the CAB server 105 can: import contact(s) information from non-CAB systems into CAB, using the CAB User's request retrieved from the CAB Feature Handler Application Usage (e.g. non-CAB address book systems related data); import/export user's External Profile from/to non-CAB systems, using the CAB User's request retrieved from the CAB Feature Handler Application Usage; and manage (e.g. retrieve, create, modify, delete) imported non-CAB address book information via XDM Agent in an address book application usage; update (e.g. retrieve, modify) a user's personal contact data via XDM Agent in PCC Application Usage, to support import requests of External Profile from non-CAB systems. The XDM Agent of the CAB server 105 can act as a supporting entity to the other CAB Server functions by supporting interactions with CAB XDMS(s) via XDM-4i 113, XDM-8.2i 115 and through SIC-2 113 interfaces.

In FIG. 1A, the CAB XDMS(s) 107 can be a server entity or a plurality of server entities. The CAB XDMS(s) 107 may be one or more CAB-specific XML Document Management servers known in the art which can support document management; manage subscription and notification of address book document; manage access permissions, and search contact information associated with information stored in the address book repository. That is, address book information is stored in XML documents or resources that are managed by the XDMS on behalf of the CAB server and CAB client.

The supplemental contact information in CAB system 100 may be implemented by a new logical function (e.g. public content function or suggestion engine) within or hosted by the CAB Server that may interact with data sources that may either provide raw information to compute the suggested data, or provide the suggested data directly. When the suggested contact data for a particular contact is determined by the aforementioned public content function (e.g. through internal logic of the suggestion engine/mechanism, and/or the available contact information within the CAB system 100), the CAB Server 105 may store the data via the Address Book Application Usage or a separate Application Usage associated with the Address Book with the CAB XDMS 107. This supplemental suggestion information may then be delivered to the CAB Client 103 using the ‘temporary’ contact card i.e. by creating a new contact and setting the contact status field for the contact entry to indicate that it is a temporary card. Furthermore the CAB Client 103 by using the ‘accept’ and ‘reject’ attributes of the temporary contact card may indicate whether the user accepts or rejects the suggested supplemental contact information.

The following XML is an example of suggested contact data in an example CAB system 100:

```
<address-book>
  <contact id=”1234”>
    <contact-status>
        <contact-source>Yahoo!<contact-source>
    <contact-status> <person-details index=”gt4fd890bu8”>
        <name>
            <name-entry index=”riuetutl” pref=”2” xml:lang=“en” name-type=”KnownAs”>
                <given>Joe</given>
                <family>Bloggs</family>
                <display-name><Joe Bloggs</display-name>
            </name-entry>
        </name>
        <address>
            <address-entry index=”ludskhf” pref=”2” addr-type=”work” xml:lang=“en”>
                <addr-string> XYZ Corporation,111 Park Avenue,Huntsville AL 11111, USA</addr-
    string>
            </address-entry>
        <address>
        <comm-addr xml:lang=“en”>
            <uri-entry index=”asdhfdsag” pref=”2” addr-uri-type=”email”>
                <addr-uri> mailto:jboggs@example.com</addr-uri>
                <label>Email</label>
            </uri-entry>
            <tel index=”nbvfjf” pref=”2” tel-type=”Mobile”>
                <tel-nb>
                    <tel-str>1-800-555-1213<tel-str>
                </tel-nb>
                <label>Personal Phone</label>
            </tel>
            <tel index=”ijlfushf” pref=”3” tel-type=”pager”>
                <tel-nb>
                    <tel-uri>tel:+1-800-555-1214</tel-uri>
                </tel-nb>
                <label>Personal Pager</label>
            </tel>
        </comm-addr>
    </contact>
    .......
    .......
    <contact>
    <contact-status>
        <contact-source>Gist</contact-source>
        <entry-status>
            <temporary confidence-level=’4’ contactIdRef=”1234”>suggested<temporary>
        <entry-status>
    <contact-status>
    <person-details index=”gt4fd890bu8”>
        <name>
            <name-entry index=”riuetutl” pref=”2” xml:lang=“en” name-type=”KnownAs”>
                <given>Joe</given>
                <family>Bloggs</family>
                <display-name><Joe Bloggs</display-name>
            </name-entry>
        </name>
        <address>
        <comm-addr xml:lang=“en”>
            <tel index=”nbvfjf” pref=”2” tel-type=”Mobile”>
                <tel-nb>
                    <tel-str>1-800-555-1111<tel-str>
                </tel-nb>
                <label>Personal Phone</label>
            </tel>
        </comm-addr>
    </contact>
```

In the above example, two contacts are shown, one with the contact entry which represents the original contact, and the temporary contact entry that represents the suggested contact information with the type of the <temporary> element set to “suggested” and the ‘confidence-level’ attribute set to value “4”. The <contact-source> element is also set to indicate the source from where the suggested data is obtained or derived. In the above example the suggested contact information is shown to be placed directly in the user's address book i.e. the address book XML document. In an alternative implementation, the suggested contact information may be stored in a separate XML document to avoid overloading the user's address book space.

To allow a choice to the user of the CAB system 100, a new user preference may be defined in the CAB User preferences XML document (in the CAB User Preferences Application Usage), for example an element <allow-suggested-contact-info> or similar that is of type boolean and with values ‘true’ to indicate that user allows the service provider to suggest supplemental contact information and ‘false’ to indicate that the user does not allow the service provider to suggest supplemental contact information.

FIG. 1B illustrates a flow chart of example operations that the CAB system 100 illustrated in FIG. 1A may perform relative to suggested contact data/information. In FIG. 1B, beginning at the CAB client 103, the CAB client 103 can set the preferences to enable suggested contact data (step 151). For example using inputs received at the CAB client 103, an option can be selected to enable suggested contact data to be retrieved and displayed at the CAB client 103. In one example embodiment, the inputs can be entered at the CAB client 103 and received by or written to a CAB XDMS User Preferences Application Usage 119. When suggested contact data is enabled, the CAB system can proceed to step 153.

At step 153, the CAB Server 105 can obtain (e.g. retrieve via a pull or receive via a push relative to a subscription, for example) public contact information to be suggested at the CAB client 103. For example, the CAB server 105 can retrieve contact information published on external public sources 117. For example, external public sources can include public phonebooks, online phonebooks, business directories, contact information published on websites such as blogs and newsfeeds, and other publicly-available data sources. In at least one example, the CAB server 105 can search the Internet for and information associated with a contact and can deliver the retrieved contact data to the CAB client. After the CAB server 105 gets public contact information, the CAB system can proceed to step 155 to determine which contact information should be suggested.

At step 155, the CAB Server 105 can analyze the obtained data based on the information available within the CAB system. The CAB server 105 can identify the supplemental contact information to be suggested to the CAB client 103. For example, the CAB server 105, through internal logic, can determine and identify a portion of the retrieved contact data which is relevant to a contact associated with the CAB client 103. The CAB server 105 can then transmit the suggested contact data to the CAB client 103. In some instances the suggested contact data may be a specific information element regarding a contact that supplements contact information that is already managed by the XDMS. However, in other instances the suggested contact data may be a plurality of information elements that comprises an entirety of a contact which may stored and managed by the XDMS. The CAB server 105 can automatically deliver the suggested contact data to the CAB client 103 upon determining which contact information should be suggested. In another example embodiment, the CAB server 105 can delay the delivery of the suggested contact data to the CAB client 103, for example at step 157.

At step 157, the CAB server 105 can store the suggested contact data in the CAB XDMS 107 for a delayed or proxied delivery to the CAB client 103. For example, the CAB Server 105 can store the suggested contact information in the CAB User's network-based Address Book using a temporary contact card. After the suggested contact information is stored, the CAB system can proceed to step 159.

At step 159, the suggested contact information can be delivered to the CAB Client 103 via an Address Book synchronization process. For example, upon initiation of a PIM (personal information management) application, the CAB can be synchronized to deliver the suggested contact information. For example, a prompt can be displayed on a device relative to the CAB client 103 when the PIM application is initiated (for example, opened or selected). The prompt can indicate that there are updates for the CAB. The CAB client user can select an option to update the CAB, thereby initiating a synchronization process in which the suggested contact information is delivered to the CAB client 103, and the CAB is updated with the suggested contact information. In another example embodiment, when the CAB client user selects the name associated with the contact having suggested contact data, a prompt can be displayed indicating that there are updates for the selected name. When the Address Book synchronization is initiated, the CAB server 105 can send instructions to the CAB Client 103 to display the suggested contact data in the same prompt that indicated that updates are available for the CAB or in another prompt. In one example, the suggested contact data can be displayed with user selectable options including an accept option or a reject option. In such an embodiment, for example, as illustrated in FIG. 1B, the CAB system can proceed to step 161.

At step 161, the user of the CAB Client 103 can select one of the accept option or the reject option. For example, each suggested contact data can be displayed with an accept option and a reject option, thereby allowing the user to accept the suggested contact data that is relevant to the user and reject the suggested contact data that is not relevant to the user. By allowing the user to accept and rejected suggested contact data, the user can customize or otherwise update the user's CAB. As the user can accept and reject particular pieces of the suggested contact data, the user can also reduce the amount of irrelevant or unnecessary contact information stored in the user's CAB, thereby conserving the storage space or memory occupied by the CAB. When an input is received corresponding to the user's acceptance or rejection of a suggested contact data, the CAB system can proceed to step 163.

At step 163, the CAB Client user's selection (acceptance or rejection) can be communicated back to the network-based Address Book. For example, the suggested contact data that has been accepted by the user can be added to the network-based Address Book. The suggested contact data that has been rejected by the user can be deleted from the temporary contact card. In another example embodiment the rejected, suggested contact data can be stored in another database, in the event another CAB Client has a contact associated with the rejected suggested contact data. After the network-based Address Book has been synchronized with the CAB Client user's selection, the CAB system can proceed to step 165.

At step 165, the CAB Server 105 can receive a notification indicative of the CAB user's decision to accept or reject the suggested contact data. The CAB Server 105 can process the notification for suggested contact data that can be sent to other CAB Clients. For example, the notification received at step 165 can affect at least one of the retrieval of suggested contact data for other CAB Clients, the determination of which retrieved contact data is suggested to other CAB clients, and the delivery of other suggested contact data to the CAB Client 103 or other CAB Clients, for example, as in step 167.

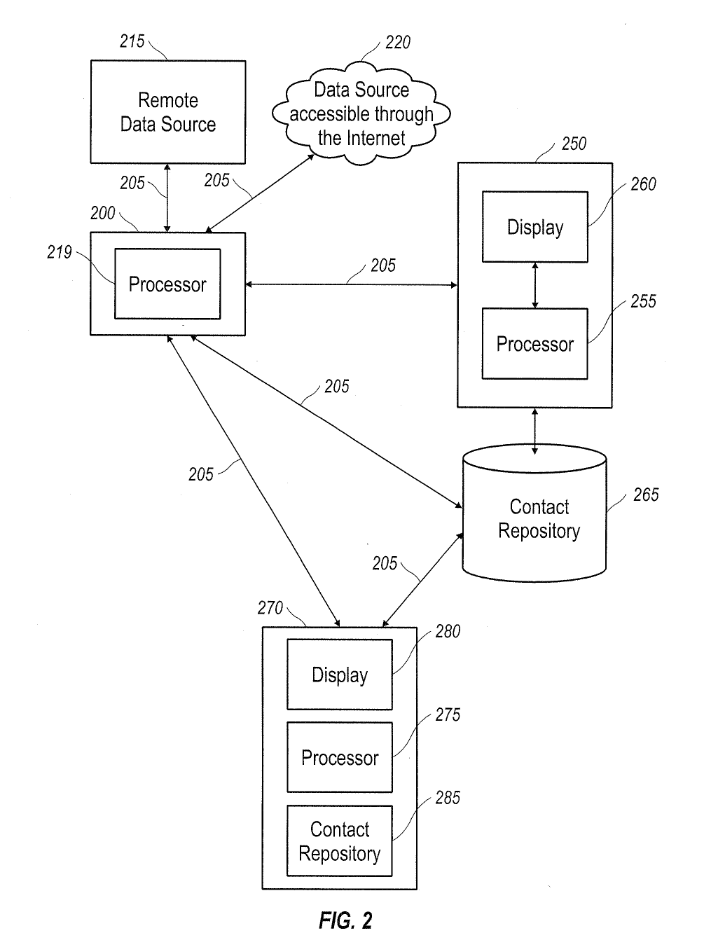

At step 167, the CAB Server 105 can retain the CAB Client user's decision for future analysis and suggestions. For example, as will be discussed in further detail below, the CAB user's decision can increase or decrease a confidence level associated with the suggested contact data. In one example embodiment, the CAB Server's 105 determination of whether to suggest a particular suggested contact data to another CAB client can be based at least in part on the CAB Client 103 user's decision to accept or reject the suggested contact data. The CAB Server 105 can also store the accepted or rejected contact data in another database for future suggestions to other CAB Clients. By storing the accepted or rejected contact data, the CAB Server 105 can conserve processing power. For example, the CAB Server 105 need not search or retrieve suggested contact data from external public sources 117, as the CAB Server 105 can already have some suggested contact data stored. The CAB Server 105 can also conserve processing power as the stored rejected or accepted suggested contact data has already been analyzed and processed. FIGS. 1A and 1B describe an example embodiment of a converged address book system in which the presently disclosed method of suggesting supplemental contact data to a computing device can be implemented. Further details as to the system and method of suggesting supplemental contact data will be discussed below with reference to FIGS. 2-5.

FIG. 2 is a block diagram illustrating the communication between a central computing device and a plurality of remote computing devices. In FIG. 2, a central computing device 200 includes a processor 219. The central computing device 200 can also include: a memory (not shown) communicatively coupled to the processor and storing instructions that are executable by the processor; and a communication interface (not shown) communicatively coupled to the processor and for allowing communication by central computing device 200 with communication network 205. The central computing device 200 can be a central processor, a server, central processor coupled to a network of computers, or any other computing device which is capable of at least searching and retrieving supplemental data for a remote computing device and includes its own power source. In some implementations, the central computing device 200 can be a network computer that hosts or otherwise executes the previously-described CAB server 105 and CAB XDMS(s) 107. The processor 219 can be directly coupled to the central computing device 200, can be indirectly coupled to the central computing device 200, or can include a plurality of processors 219 indirectly or directly coupled to the central computing device 200. The processor 219 can be configured to execute instructions carried out on the central computing device 200 and can be configured to transmit requests for instructions to be carried out on a remote computing device 250, 270. As illustrated in FIG. 2, the central computing device 200 is communicatively coupled to and can be configured to access at least one remote data source 215, 220 via communication network. For example, in FIG. 2, the central computing device 200 can be configured to access a data source accessible through the Internet 220, a website, a webserver, a public database, a remote server, a remote database, a third-party database, a data source of a social network, a database hosted on a cloud network, or any other remote data source 215 from which the central computing device 200 can retrieve supplemental contact data. For example, the central computing device 200 can access data sources of a social network (such as Facebook™, LinkedIn™, or other social network), where contact data can be stored, posted, and searched, to obtain suggested contact data. For example, the central computing device 200 can access the data source of the social networks in which the user of the remote computing device 250, 270 is a member and can search profiles and other data hosted on the social networks for updated and changed contact data to suggest to the remote computing device 250, 270 of the user.

Also in FIG. 2, the central computing device 200 can be communicatively coupled to at least one remote computing device 250, 270. In FIG. 2, the central computing device 200 is communicatively coupled to two remote computing devices 250, 270. However, those of ordinary skill in the art will appreciate that fewer or more remote computing devices can be implemented than as illustrated in FIG. 2. In FIG. 2, the remote computing devices 250, 270, can be mobile communication devices, mobile computers, smartphones, electronic pads, electronic tablets, desktop computers, laptop computers, netbooks, or other computing devices capable of at least accepting data, transmitting data, and executing commands and includes its own power source. In some implementations remote computing devices 250, 270 may be configured to execute or host the previously-described CAB client 103. One of the remote computing devices 250 can include a display 260 on which graphical and textual data can be displayed. The remote computing device 250 can also include a processor 255. A remote computing device 250 can also include: a memory (not shown) communicatively coupled to the processor and storing instructions that are executable by the processor; and a communication interface (not shown) communicatively coupled to the processor and for allowing communication by remote computing device 250 with communication network 205. The processor 255 can be directly coupled to the remote computing device 250, can be indirectly coupled to the remote computing device 250, or can include a plurality of processors indirectly or directly coupled to the remote computing device 250. The processor 250 can be configured to execute instructions carried out on the remote computing device 250 and can be configured to receive instructions from the central computing device 200. The processor 255 can be communicatively coupled to the display 260 and a contact repository 265, such that information from the contact repository 265 can be displayed on the display 260. In FIG. 2, the remote computing device 250 can be indirectly coupled to the repository 265. For example, the contact repository 265 can be stored on an external server, an external database, a database stored on a cloud network, an database hosted on a multi-tenant database and accessible by another computing device, a database managed by a wireless provider of the remote computing device 250, a converged address book server, a website, or other database accessible the remote computing device 250. (In an example embodiment, contact repository 265 includes: a processor (not shown), a memory (not shown) communicatively coupled to the processor and storing instructions that are executable by the processor; and a communication interface (not shown) communicatively coupled to the processor and for allowing communication by contact repository 265 with communication network 205.) In some implementations the contact repository 265 may be a network computer executing an application server such as one or more XDMS(s) as previously described for managing a database or data structure of contact information. For example, in at least one example embodiment, the remote computing device 250 can be coupled to the contact repository 265 such that the contact repository 265 is accessed via a mobile Internet browser, a mobile phone application, a web application, or any other platform which permits information from the contact repository 265 to be displayed on the display 260 of the remote computing device 250. In another example embodiment, the contact repository 265 can include a contact search engine configured to access a plurality of contact repositories associated with the user (for example, a user's work contact repository, a user's personal contact repository, or other contact repositories) or can be configured to access a converged contact repository which has been configured to compile and converge a plurality of repositories associated with the user.

In at least one example embodiment, as the contact repository 265 is remotely stored on a storage medium indirectly accessible by the remote computing device 250, the central computing device 200 can also access the contact repository 265. For example, the central computing device 200 can be permitted to search, retrieve, delete, supplement, and update contact entries, including contact data, stored on the contact repository 265. A contact entry can include a profile in which at least one of a name of a contact, a home phone number, a mobile phone number, a work phone number, a home address, a name of an employer, a work address, an email address, a website, or other contact data can be stored.

In other example embodiments, the remote computing device can be directly coupled to the contact repository. For example, also illustrated in FIG. 2, the other remote computing device 270 can be directly coupled to or otherwise configured to be unitary or integral with a corresponding contact repository 285. In another example embodiment, contact repository 285 contains at least a local subset of address book information (for example, contact entries which include contact data) that is contained in the network-based contact repository 265, and computing device 270 and a server storing contact repository 265 are configured to synchronize modifications (for example, add, delete, modify) made to either the local subset at contact repository 285 or at contact repository 265. As illustrated in FIG. 2, the other remote computing device 270 includes a corresponding display 280 on which graphical and textual information can be displayed. The other remote computing device 270 can also include a corresponding processor 275. (Remote computing device 270 also includes: a memory (not shown) communicatively coupled to the processor and storing instructions that are executable by the processor; and a communication interface (not shown) communicatively coupled to the processor and for allowing communication by remote computing device 270 with communication network 205.) The corresponding processor 275 can be communicatively coupled to the display 280 and a contact repository 285, such that information from the corresponding contact repository 285 can be displayed on the corresponding display 280. In the other remote computing device 270, the contact repository 285 can be directly coupled to the respective computing device 270. For example, the contact repository 285 can be stored on computer storage medium directly coupled to the computing device, such as an secure digital (SD) card, a non-transitory memory coupled to the computing device 270, a memory card, or other storage medium which can be directly coupled to the computing device 270 and which can store information accessible by the computing device 270 thereon.

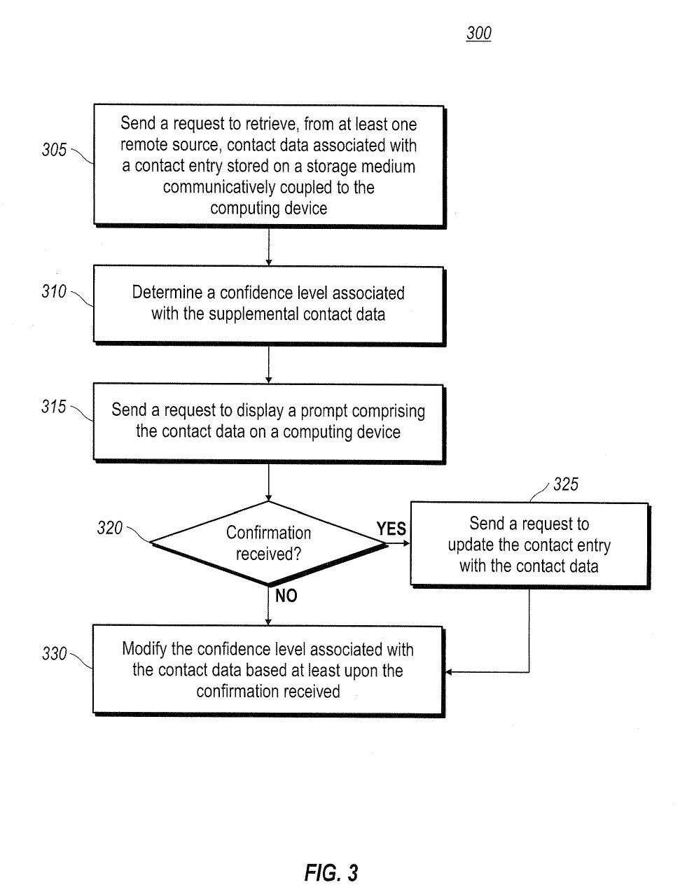

Also illustrated in FIG. 2, the central computing device 200 can be communicatively coupled to at least one of the remote computing device 250, 270 and contact repository 265, via communication network 205. For example, the communication network can be a telecommunication network, a wireless communication network, a computer network, a local area network, a wide area network, a near field communication network, a combination of networks and interfaces, a point-to-point network, a star network, a token ring network, a hub network, or other appropriate configuration. In at least one example embodiment in which a computer network is utilized, the computer network can be a TCP/IP (Transfer Control Protocol and Internet Protocol) network, such as the global internetwork of networks often referred to as the internet. User systems can communicate with the central computing device 200 using TCP/IP and, at a higher network level, use other common Internet protocols to communicate, such as Hypertext Transfer Protocol (HTTP), File Transfer Protocol (FTP), Andrew File System (AFS), Wireless Application Protocol (WAP), or other protocols. In an example where HTTP is used, the central computing device 200 can include an HTTP client commonly referred to as a “browser” for sending and receiving HTTP messages to and from an HTTP server communicatively coupled to the central computing device 200. Such an HTTP server can be implemented as the sole network interface between central computing device 200 and remote computing devices 250, 270, but other techniques might be used as well or instead. Those of skill in the art will understand that an Internet protocol is provided as a non-limiting example implementation for illustrative purposes, and other networks and interfaces are considered within the scope of the present disclosure, so long as the network or interface allows a central computing device 200 to communicate suggested data to at least one remote computing device 250, 270. Details as to the method for suggesting data to a computing device will be described with respect to the flow chart illustrated in FIG. 3.

FIG. 3 is a flow chart of an example embodiment of a method 300 for suggesting data performed by a computing device. The method 300 illustrated in FIG. 3 is provided by way of example, as there are a variety of ways to carry out the method. Additionally, while the example method 300 is illustrated with a particular order of steps, those of ordinary skill in the art will appreciate the steps illustrated therein can be executed in any order and can include fewer or more steps than as illustrated. The method 300 can be carried out using a computing device communicatively coupled to at least one remote computing device 250, 270 as illustrated in FIG. 2, in an example embodiment. Each block shown in FIG. 3 represents one or more processes, methods or subroutines, carried out in example method 300. For example, each block shown in FIG. 3 can be carried out by the processor 219 of the central computing device 200 illustrated in FIG. 2.

In FIG. 3, the method 300 can begin a block 305. At block 305, a request can be sent to retrieve from at least one remote data source, contact data associated with a contact entry stored on a storage medium (for example, a contact repository 265, 285) communicatively coupled to a computing device (for example, a remote computing device 250, 270). For example, central computing device 200 can send a request to at least one remote data source to retrieve the contact data associated with a contact entry. The remote data sources can include the Internet 220, a website, a webserver, a public database, a remote server, a remote database, a third-party database, a data source of a social network, a database hosted on a cloud network, or any other remote data source 215. The central computing device 200 can subsequently suggest to the remote computing device 250, 270 to supplement and update the contact entry. For example, in at least one implementation, the central computing device 200 can send a request for a web crawler to search the Internet for information or data related to a contact entry stored on a storage medium coupled to a remote device. In another example embodiment, the central computing device 200 can send a request to search for updated telephone numbers and email addresses associated with the contact entry. For example, if a contact has moved or changed jobs, it is likely that at least one of a new business address, a new work phone number, a new work mobile phone number, a new website, and a new email address. In the event the contact does not inform the user of the remote computing device 250, 270 that the contact's data has been updated, the user's contact repository can be outdated, incorrect, and incomplete. Therefore, at block 305, central computing device 200 can search the Internet for (for example, via a search engine) and retrieve or otherwise obtain contact information associated with the contact. For example, the central computing device 200 can retrieve the new work phone number, new email address, new website, or other contact data. After contact data is retrieved from at least one remote data source, the method 300 can proceed to block 310.

At block 310, a confidence level associated with the suggested contact data can be determined. For example, the processor 219 of the central computing device 200 can determine and associate a confidence level associated with the suggested contact data. As described above, the suggested contact data can include a work phone number, an email address, a new website, a blog address, a social networking profile, a mobile phone number, a home address, other publicly available information related to the contact associated with the contact entry, or other information available and accessible by the central computing device 200 which the central computing device 200 can retrieve and suggest to a remote computing device 250, 270. In at least one example embodiment, the confidence level can represent the central computing device's 200 confidence that the retrieved suggested contact data is associated with (or relevant to) the contact entry.

The confidence level can represent that the central computing device 200 is confident that the retrieved suggested contact data is associated with the contact entry and not with another contact having a similar name. The confidence level can be based at least in part upon one or any combination of the following: the number of remote data sources which have published the retrieved contact data, a credibility value associated with the remote data source, the reputation of the remote data source(s) from which the contact data was retrieved, a confirmation of the suggested contact data received from another remote computing device (for example, a secondary computing device), confirmations from a plurality of secondary computing devices, the number of other computing devices or contact repositories which have the retrieved contact data stored thereon, the number of other computing devices which have accepted the retrieved contact data, or other parameters or factors which can indicate whether retrieved contact data is reliable. In at least one example embodiment, the confidence level can be represented as an indicium such as a value derived by the computing device 200 and associated with the suggested contact data. For example, the value can be a numerical value, a percentage, an integer, an integer out of a maximum value (for example eight out of ten, 80 out of 100, etc.), a fraction, an alphabetic value (for example, letter grades, such as A being reliable and F being unreliable, etc.), a star rating (for example, one star being unreliable and five stars being very reliable, etc.), a bar rating (for example, one bar being unreliable and five bars being very reliable), a thumbs up-thumbs down rating, a color rating (for example, green being reliable and red being unreliable) or any other value or rating which can be representative of the accuracy or reliability of the suggested contact data. When the confidence level has been determined and associated with the suggested contact data, the method can proceed to block 315.

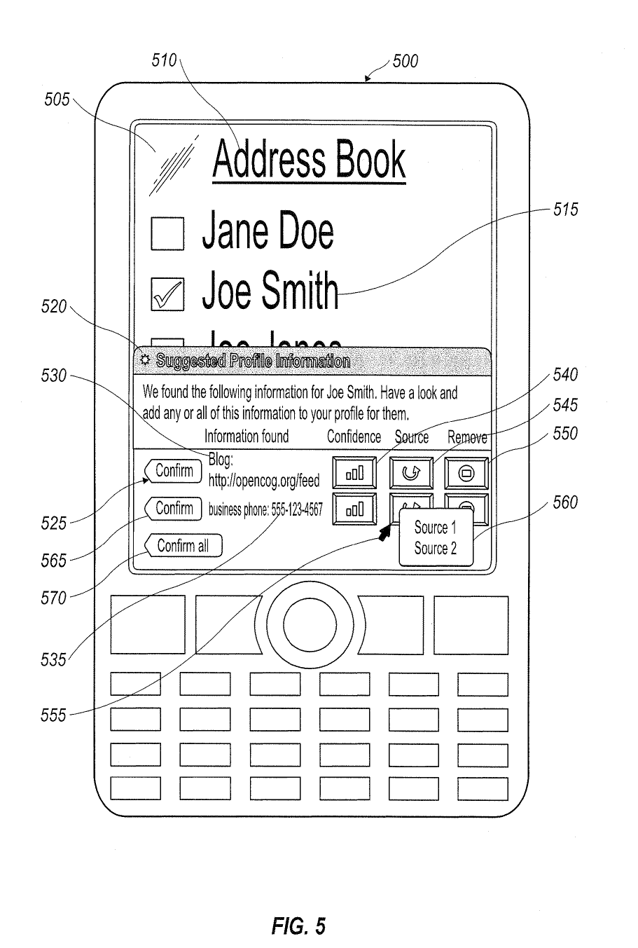

At block 315, a request to display a prompt, at the remote computing device 250, 270 can be sent. For example, the central computing device 200 can send a request to the remote computing device 250, 270 to display a prompt 520 (shown in FIG. 5). The prompt can include one or more suggested contact data, for example a plurality of suggested contact data. In another example embodiment, the prompt can also include one or more of the following: the confidence level corresponding to each suggested contact data; a source identifier for each corresponding suggested contact data, the source identified representing the at least one remote data source from which the corresponding suggested contact data was retrieved; a plurality of contact entries having respective suggested contact data; or other graphical, textual or both graphical and textual data retrieved from at least one remote data source. In at least one example embodiment, the prompt can also include a user-selectable input for each suggested contact data. The user-selectable input can include at least an accept option and a reject option, which the user of the remote computing device can select to accept or reject the corresponding suggested contact data.

The remote computing device 250, 270 can receive the request to display the prompt 520. In response to the request to display the prompt, remote computing device 250, 270 can execute instructions to display the prompt. Those skilled in the art will appreciate that sending the request to display the prompt and displaying the prompt at the remote computing device 250, 270 can be carried out by a plurality of processes and methods. For example, sending the request to display the prompt can be carried by a method executed by the central computing device 200. Displaying the prompt can be carried out by a method executed by the remote computing device 250, 270 on which the prompt will be displayed.

At block 320, a determination can be made as to whether a confirmation has been received from the remote computing device 250, 270. For example, at block 320, the central computing device 200 can receive a confirmation from the remote computing device 250, 270 on which the suggested contact data has been displayed. The confirmation can be one of an acceptance and a rejection of the suggested contact data.

In the event the confirmation received at block 320 is a rejection of the suggested contact data, the method can proceed to block 330. At block 330, the confidence level associated with the contact data can be modified based at least upon the rejection confirmation received. For example, the rejection can indicate that the corresponding suggested contact data is incorrect, associated with the wrong contact entry, irrelevant to the user of the remote computing device 250, 270, or is otherwise of little value to the user of the remote computing device 250, 270. For example, the suggested contact data can be a phone number associated with another person having the same name as the contact entry stored on the remote computing device's contact repository. In at least one example embodiment, in the event the confirmation is a rejection, modifying the confidence level can include assigning a downvote to the confidence level. For example, in at least one non-limiting example embodiment, the confidence level can be assigned with a negative indicator, such as a thumbs down, a negative number, a red flag, one less star rating, or other negative indicator representing an unreliability of the suggested contact data. If the confidence level is assigned a number of downvotes that exceeds a predetermined number of downvotes, the central computing device 200 can: stop sending requests to display the corresponding suggested contact data on a remote computing device 250, 270; can dispose of or expunge the suggested contact data; can send a notification to remote computing devices 250, 270 to remove the suggested contact data stored in their respective contact repositories; can send notifications to remote devices 250, 270 which have the suggested contact data stored thereon, indicating the confidence level associated with the suggested contact data has been modified; or can otherwise reduce the distribution of the downvoted suggested contact data (for example, incorrect, inaccurate, or irrelevant contact data) to other remote computing devices.

In another example embodiment, in the event a confirmation is received that is a rejection, modifying the confidence level at block 330 can include decreasing a value corresponding to the confidence level. For example, in an example embodiment where the confidence level is a numerical value and a confirmation is a rejection, the numerical value corresponding the confidence level of the suggested contact data can be: subtracted by a predetermined number, divided by a rejection multiplier, multiplied by a rejection multiplier, or otherwise decreased to represent a decrease in the reliability or confidence of the suggested contact data. In at least one example embodiment, the rejection multiplier can be an integer, a negative integer, a fraction, or other value that decreases the value associated with the confidence level. In another example embodiment, the rejection multiplier can be greater than an acceptance value (as will be described below). In such an example embodiment where the rejection multiplier is greater than an acceptance multiplier, the rejection of a suggested contact data affects the confidence level (and therefore, the likelihood that the corresponding suggested contact data is suggested to another remote computing device) more so than an acceptance of the suggested contact data. That is, in at least one example embodiment, incorrect suggested contact data can be quickly identified and removed from a queue of suggested contact data as the negative effect on the confidence level of a rejection suggested contact data is greater than a positive effect of accepting the suggested contact data. Therefore, a rejection of the suggested contact data can modify the confidence level to increase the accuracy of suggested contact data suggested by the central computing device 200, since incorrect suggested contact data can be identified and prevented from being suggested by the central computing device 200.

In at least one example embodiment, in response to receiving a confirmation that is a rejection at block 320 and after modifying the confidence level associated with the suggested contact data at block 330, a request to exit the prompt can be sent. For example, in response to receiving a confirmation that is a rejection and after the confidence level has been modified, the prompt which contained the suggested contact data can be removed from the display 260 of the remote computing device 250. Exiting the prompt can terminate a current session of suggesting contact data to the remote computing device 250.

In the event a confirmation is received and the confirmation is an acceptance, the method can proceed to block 325. At block 325, central computing device 200 can send the request to the remote computing device 250, 270 to update the contact entry with the suggested contact data. In another example embodiment, the central computing device 200 can send the request to a host computing device or a host server communicatively coupled to and configured to manage the contact repository on which the contact entry can be stored. For example, if the suggested contact data is a new work phone number associated with the contact entry and the remote computing device 250, 270 has transmitted an input to the central computing device 200 to accept the new work phone number, the central computing device 200 can send a request to the remote computing device 250, 270 to update the contact entry stored in the contact repository with the new work phone number. In another example embodiment, the central computing device 200 can supplement the contact entry with the new work phone number, delete an old work phone number, replace an old work phone number with the new work phone number, or simply add the new work phone number contact entry. In another example embodiment, the central computing device 200 can send a request to a host device of the contact repository to which the computing device is indirectly coupled to update, supplement, or edit the contact entry with the accepted suggested contact data. In response to receiving the request to update the contact entry, the remote computing device 250, 270 can execute instructions to update the contact entry with the suggested contact data. In another example embodiment, where the contact entry is hosted by a host computing device or a host server, the host server can execute instructions to update the contact entry with the suggest contact data. After the contact entry has been updated with the accepted suggested contact data, the method can proceed to block 330.

At block 330, for example, via the processor of the central computing device 200, in the event the confirmation is an acceptance, the confidence level associated with the suggested contact data can be modified based on the acceptance. In at least one example embodiment, the method can assign an upvote to the confidence level. For example, the acceptance can indicate that the corresponding suggested contact data is correct, accurately associated with the contact entry, relevant to the user of the remote computing device 250, 270, or is otherwise of value to the user of the remote computing device 250, 270. In at least one non-limiting example embodiment, assigning an upvote can include assigning a positive indicator to the confidence level. For example, an upvote can include a thumbs up, a positive number, a green flag, an additional star rating, an additional partial star rating or other positive indicator representing an increased reliability of the suggested contact data. If the confidence level is assigned a number of upvotes that exceeds a predetermined number of upvotes, the central computing device 200 can: continue to send requests to display the corresponding suggested contact data on other remote computing devices 270; can automatically update a contact entry stored on another medium coupled to another remote computing device 250, 270 without confirmation from the another remote computing device 270; or can send notifications, to other remote devices 250, 270 which have the suggested contact data stored thereon, indicating the confidence level associated with the suggested contact data has been modified to increase the reliability of the suggested contact data.

In the event a confirmation is received that is an acceptance, modifying the confidence level at block 330 can include increasing a value corresponding to the confidence level. For example, in an example embodiment where the confidence level is a numerical value and a confirmation is an acceptance, the numerical value corresponding the confidence level of the suggested contact data can be: added by a predetermined number, multiplied by an acceptance multiplier, or otherwise increased to represent an increase in the reliability or confidence of the suggested contact data. In at least one example embodiment, the acceptance multiplier can be an integer, a positive integer, a fraction, or other value that increases the value associated with the confidence level. Therefore, an acceptance of suggested contact data can modify the confidence level associated therewith to increase the accuracy of suggested contact data suggested by the central computing device 200 since suggested contact data is confirmed by each user who receives the suggested contact data, thereby increasing the number of people who confirm the accuracy or reliability of the suggested contact data.

The method 300 can further include comparing the modified confidence level modified at block 330 to a first predetermined threshold or a predetermined value. For example, in the event the modified confidence level is increased and exceeds a first predetermined threshold or is substantially greater than a first predetermined value, the method can store the corresponding suggested contact data in a first database including contact data and corresponding confidence levels indicative of a high reliability.

In another non-limiting example where the event the modified confidence level is decreased and falls below a second predetermined threshold or is substantially less than a second predetermined value, the method can store the corresponding suggested contact data in a second database including contact data and corresponding confidence levels indicative of low reliability. In such an example embodiment, the suggested contact data that has been rejected can be stored and utilized for reference in determining whether or not to suggest contact data to a remote computing device 250, 270. The suggested contact data that has been confirmed can be stored and retrieved by the central computing device 200 in the event a secondary remote computing device 250, 270 adds a contact entry associated with the confirmed suggested contact data. In such an example embodiment, suggesting contact data to a remote computing device does not necessarily have to confirm the reliability of retrieved suggested contact data each time the suggested contact data is received, as the suggested contact data which fall substantially above or below the first or second predetermined threshold or first or second predetermined value are confidently considered reliable or unreliable.

In another example embodiment where the modified confidence level of the associated contact data is below a second predetermined threshold or is substantially less than a predetermined value, the method 300 can modify a second prompt to be displayed on a second remote computing device 170. For example, the second prompt can be modified: by displaying the suggested contact data with the modified confidence level, by displaying the suggested contact data at a lower rank than other suggested contact data, by removing the suggested contact data from the second prompt, or any other modification to the second prompt that indicates that the suggested contact data is less reliable.

In yet another example embodiment, in which a plurality of suggested contact data is included in a prompt displayed on a remote computing device 150, the confidence level can affect an order in which the plurality of suggested contact data is displayed. For example, the suggested contact data having the highest confidence level can be displayed first, and the suggested contact data having the lowest confidence level can be displayed last. In another example embodiment, the vice versa can be displayed. In another example embodiment, modified confidence levels resulting from the confirmation of suggested contact data at a first remote computing device 250 can affect an order in which a plurality of suggested contact data is displayed on a second remote computing device 270.

In another example embodiment where a suggested contact data can have an associated confidence level that is below the predetermined threshold, if the suggested contact data is presented to a plurality of other secondary remote computing devices, and each of those secondary remote computing devices confirms the suggested contact data, the confidence level associated therewith can be modified to increase the associated confidence level that is greater than the predetermined threshold that is associated with the second database but is less than the a predetermined threshold that is associated with the first database (for example, a first predetermined threshold). In such an example embodiment, the suggested contact data can be presented on further secondary computing devices 250, 270 until the confidence level is modified to be substantially above the first predetermined threshold or substantially below the second predetermined threshold. Therefore, in such an example embodiment where the confidence levels associated with the suggested contact data are dynamic, thereby providing increasing accuracy of suggested contact data suggested by the central computing device 200. Additionally, in such an example embodiment, the dynamic confidence levels associated with the suggested contact data can increase the accuracy and reliability of contact data of contact entries stored on storage mediums communicatively coupled to remote computing devices 250, 270.

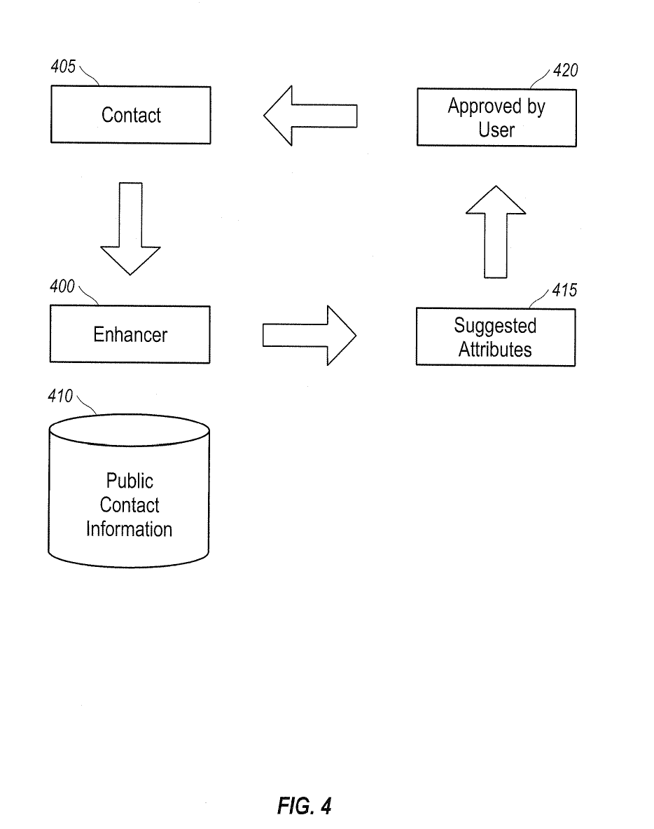

FIG. 4 is a high-level flow chart of an example embodiment of the present method of suggesting data to a computing device illustrating the effect of a user's approval of suggested data associated with a contact stored by the user's remote computing device. As illustrated in FIG. 4, a contact entry 405 can be presented on remote computing device 250. The contact entry 405 can be updated by an enhancer 400, such as a central computing device 200. The enhancer 400 can search for and retrieve supplemental or enhancing contact data associated and related to the contact entry 405 to enhance or supplement the contact entry 405. As illustrated in FIG. 4, the enhancer 400 can retrieve the supplemental or enhancing contact data from a remote data source, such as public contact information stored on a publicly available database 410. In FIG. 4, the enhancer 400 can compile the retrieved supplemental or enhancing contact data and present the supplemental or enhancing contact data as suggested attributes 415 at the remote computing device 250. The suggested attribute 415 can include a user-selectable option which the user of the remote computing device 250 can select to approve the suggested attributes 415. If the suggested attributes 415 are approved 420, the suggested attributes can be added or supplemented to the contact entry 405. If the suggested attributes 415 are corrected attributes of data currently stored in the contact entry 405, the suggested attributes 415 can replace the incorrect and outdated data stored in the contact entry 405. In other example embodiments, the enhancer 400 can: retrieve and suggest suggested attributes for each of the contact entries 405 stored by the user's remote computing device 250, retrieve and suggest suggested attributes for the most recent contact entries 405 stored by the user's remote computing device 250, the least recent contact entries 405 stored by the user's remote computing device 250, the most contact entries 405 most frequently selected or communicated with by user of the remote computing device 250, contact entries 405 selected by the user of the remote computing device 250 for supplementing or enhancing, or any other selection, group, or combination of contact entries 405 which can be supplemented or enhanced. Those of ordinary skill in the art will appreciate that the example embodiment illustrated in FIG. 4 is non-limiting, and other example embodiments which achieve the technical advantages of the presently disclosed system and method of suggesting supplemental data on a computing device are considered within the scope of the present disclosure. Those of ordinary skill in the art will also appreciate that the features disclosed in FIG. 4 can be optionally included and can be combined or interchanged with the features described and illustrated in FIGS. 1-3, and 5.

FIG. 5 is a view of a remote computing device configured to receive and display suggested contact data in accordance with an example non-limiting embodiment of the present disclosure. In FIG. 5, the remote computing device 500 is a smartphone. (In an example embodiment, remote computing device 500 includes a processor (not shown) Communicatively coupled to the processor are: a memory (not shown) storing instructions that are executable by the processor; a communication interface (not shown) for allowing communication by remote computing device 500 with communication network 205, input devices (e.g. display 505 including graphical representations and configured to receive inputs) and output devices (e.g. display 505 including graphical representations for presenting information). As illustrated in FIG. 5, the remote computing device 500 includes a display 505. For example, the display 505 can be a liquid crystal display (LCD), a light emitting diode (LED) display, an active matrix organic light emitting diode (AMOLED) display, a cathode ray tube display, or any other display which can be configured to display graphical and textual information. In FIG. 5, the remote computing device 500 or a processor (not shown) communicatively coupled to the remote computing device 500 can execute an application which allows the user to access a contact repository (not shown). For example, the application can be an address book application 510, as illustrated in FIG. 5, a converged address book application which is configured to compile contact data from a plurality of address books (for example, a user's mail address book, cell phone address book, work address book, or other address book), an address book monitoring application which can be configured to monitor and compile contact data from a plurality of various sources. The address book application 510 can display a list of a plurality of contact entries 515. In at least one example embodiment, when the address book application 510 is launched, a prompt 520 can be displayed on the display 505 of the remote computing device 500. For example, the prompt 520 can be displayed over at least a portion of a user interface of the address book application 510, can be displayed prior to displaying the user interface of the address book application 510, can be displayed as a hyperlink in response to accessing an address book application hosted by a web application or a website, can be displayed in a separate window from the window displaying the address book application, or can be displayed elsewhere on the remote computing device 500.

As illustrated in FIG. 5, the prompt 520 can display suggested contact data 525 associated with a contact entry 515. For example, in FIG. 5, the suggested contact data 525 can be a plurality of suggested contact data 530, 535. In FIG. 5, two pieces of suggested contact data 525 associated with one contact entry 515, Joe Smith: a blog site authored by the person associated with the contact entry 515 and a business phone number 535 of the person associated with the contact entry 515. Those of ordinary skill in the art will appreciate that fewer or more suggested contact data 525 can be displayed in the prompt 520. Those skilled in the art will also appreciate that other suggested contact data 525 can be displayed other than as illustrated in FIG. 5. It will also be appreciated that the prompt 520 can include suggested contact data 525 can each be associated with a different contact entry 515, a plurality of suggested contact data 525 associated with one contact entry 515, a plurality of suggested contact data 525 associated with one contact entry 515 and a suggested contact entry associated with another contact entry 515, suggested data based upon a global change (for example, if a company changes the company's name), or any other combination thereof.

As illustrated in FIG. 5, the prompt 520 can also include a graphical representation of a confidence level 540 associated with the suggested contact data 525. For example, as illustrated in FIG. 5, the graphical representation of the confidence level 540 can be a selectable button, wherein selecting the button can display additional information pertaining to the confidence level 540. For example, the additional information can be the value corresponding to the confidence level 540, a number of users who provided a confirmation on which the confidence level 540 is based, a last modified date, or other information pertaining to the confidence level 540 associated with the suggested contact data 525. In other implementations, the graphical representation of the confidence level 540 can be an icon, a graphical image, text or other representation which can indicate the confidence level 540 associated with the suggested contact data 525. In either of these example embodiments, the additional information pertaining to the confidence level 540 can be displayed along with the graphical representation of the confidence level 540. For example, in at least one example embodiment, when a pointing device 555 (for example, a cursor) is positioned proximate to the graphical representation of the confidence level 540, a pop-up box, a hovering box, a overlaid box, or other window can be displayed proximate to the graphical representation of the confidence level 540 to display additional information pertaining to the confidence level 540, such as those described above. In at least one example embodiment, the additional information can be displayed in response to the pointing device 555 being positioned over or on top of the graphical representation of the confidence level 540; however, those of ordinary skill in the art will appreciate the other positions of the pointing device 555 can cause the display of the additional information pertaining to the confidence level 540. As illustrated in FIG. 5, each of the suggested contact data 530, 535 has a corresponding graphical representation of the confidence level 540 associated with the respective suggested contact data 530, 535.

The prompt 520 can include a graphical representation of a source 545 from which the corresponding suggested contact data 525 was retrieved. For example, in FIG. 5, the graphical representation of the source 545 can be a selectable button, wherein selecting the button can display additional information pertaining to the source 545. For example, the additional information can be the source or sources 545 from which the corresponding data 525 was retrieved. In other implementations, the graphical representation of source(s) 545 can be an icon, a graphical image, text or other representation which can indicate the source(s) 545 from which the corresponding suggested contact data was retrieved. In either of these example embodiments, the additional information pertaining to the source 545 can be displayed along with the graphical representation of the source 545. For example, in at least one example embodiment, when a pointing device 555 (for example, a cursor) is positioned proximate to the graphical representation of the source 545, a pop-up box, a hovering box, a overlaid box 560 (as illustrated in FIG. 5), or other window can be displayed proximate to the graphical representation of the source 545 to display additional information pertaining to the source 545. In at least one example embodiment, the additional information can be displayed in response to the pointing device 555 being positioned over or on top of the graphical representation of the source 545; however, those of ordinary skill in the art will appreciate the other positions of the pointing device 555 can cause the display of the additional information pertaining to the source 545. As illustrated in FIG. 5, each of the suggested contact data 530, 535 has a corresponding graphical representation of the source 545 associated with the respective suggested contact data 530, 535.

Also illustrated in FIG. 5, the prompt 520 can include a user-selectable input 550, 525, 565 for each suggested contact data 530, 535. For example, in FIG. 5, the user-selectable input can include at least an accept option 525, 565 and a rejection option 550 for each suggested contact data 530, 535. In FIG. 5, the user-selectable inputs 550, 525, 565 can be user-selectable buttons, icons, or other graphical representations of an accept option 525, 565 and a rejection option 550. The user-selectable input corresponding to the accept option 525, 565 can be selected to accept the corresponding suggested contact data 530, 535. As a result of selecting the accept option 525, 565, the confidence level associated with the corresponding suggested contact data 530, 535 can be modified. Additionally, in response to selecting the accept option 525, 565, the suggested contact data 530, 535, the contact entry 515 associated with the suggested contact data 530, 535 can be updated or supplemented with the suggested contact data 530, 535. In at least one example embodiment, as illustrated in FIG. 5, the prompt 520 can include a user-selectable input 570 which can be selected to accept all of the suggested contact data 530, 535 displayed in the prompt 520 by one selection. In another example embodiment, the prompt 520 can include a user-selectable input which can be selected to reject all of the suggested contact data 530, 535 displayed in the prompt 520 by one selection.

The user-selectable input corresponding to the rejection option 550 can be selected to reject the corresponding suggested contact data 530, 535. As a result of selecting the rejection option 550, the confidence level associated with the corresponding suggested contact data 530, 535 can be modified. Additionally, in response to selecting the rejection option 550, the corresponding suggested contact data 530, 535 can be removed from the prompt 520, expunged from a queue of suggested contact data 530, 535, removed from other associated contact entries saved on contact repositories communicatively coupled to other remote computing devices, or otherwise discarded by the central computing device 200 (shown in FIG. 2) which is configured to retrieve and suggest suggested contact data 530, 535.

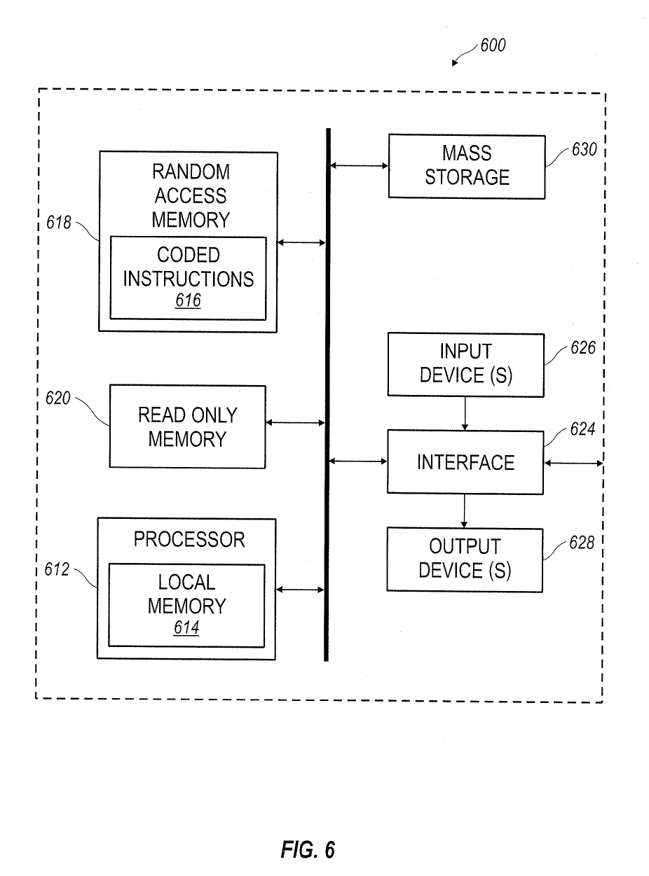

FIG. 6 is a block diagram of an example processing system 600 capable of implementing the apparatus and methods disclosed herein. The processing system 600 can correspond to, for example, CAB client 103, CAB server 105, CAB XDMS(s) 107, contact repository 265, remote devices 205, 207, 500, a mobile station processing platform, a network element processing platform, a server, a network computer, a personal computer, a personal digital assistant (PDA), an Internet appliance, a mobile phone, or any other type of computing device.

The system 600 of the instant example includes a processor 612 such as a general purpose programmable processor, an embedded processor, a microcontroller, etc. The processor 612 includes a local memory 614, and executes coded instructions 616 present in the local memory 614 and/or in another memory device. The processor 612 may execute, among other things, machine readable instructions to implement any, some or all of the methods represented in FIGS. 1B, 3 and 4. The processor 612 may be any type of processing unit, such as one or more microprocessors from the Intel® Centrino® family of microprocessors, the Intel® Pentium® family of microprocessors, the Intel® Itanium® family of microprocessors, and/or the Intel® XScale® family of processors, one or more microcontrollers from the ARM® family of microcontrollers, the PIC® family of microcontrollers, etc. Of course, other processors from other families are also appropriate.

The processor 612 is in communication with a main memory including a volatile memory 618 and a non-volatile memory 620 via a bus 622. The volatile memory 618 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 620 may be implemented by flash memory and/or any other desired type of memory device. Access to the main memory 618, 620 is typically controlled by a memory controller (not shown).

The system 600 also includes an interface circuit 624. The interface circuit 624 may be implemented by any type of interface standard, such as an Ethernet interface, a universal serial bus (USB), and/or a third generation input/output (3GIO) interface.

One or more input devices 626 are connected to the interface circuit 624. The input device(s) 626 permit a user to enter data and commands into the processor 612. The input device(s) can be implemented by, for example, a keyboard, a mouse, a touchscreen, a track-pad, a trackball, an isopoint and/or a voice recognition system.

One or more output devices 628 are also connected to the interface circuit 624. The output devices 628 can be implemented, for example, by display devices (e.g., a liquid crystal display, a cathode ray tube display (CRT)), by a printer and/or by speakers. The interface circuit 624, thus, typically includes a graphics driver card.

The interface circuit 624 also includes a communication interface such as a modem or network interface card to facilitate exchange of data with external computers via a network (e.g., an Ethernet connection, a digital subscriber line (DSL), a telephone line, coaxial cable, a cellular telephone system such as an EGPRS-compliant system, etc.).

The system 600 also includes one or more mass storage devices 630 for storing software and data. Examples of such mass storage devices 630 include floppy disk drives, hard drive disks, compact disk drives and digital versatile disk (DVD) drives.

As an alternative to implementing the methods and/or apparatus described herein in a system such as shown in FIG. 6, the methods and or apparatus described herein may be embedded in a structure such as a processor and/or an ASIC (application specific integrated circuit).

Example implementations have been described hereinabove regarding a system and method of suggesting supplemental data on a computing device. One of ordinary skill in the art will also appreciate that the elements and features illustrated in the example embodiments described and illustrated in the figures herein can be optionally included to achieve the benefits of the presently disclosed system and method of suggesting supplemental data on a computing device. Additionally, those skilled in the art will appreciate that features in each of the figures described herein can be combined with one another and arrange to achieve the described benefits of the presently disclosed system and method of suggesting supplemental data on a computing device. Various modifications to and departures from the disclosed implementations will occur to those having skill in the art. The subject matter that is intended to be within the spirit of this disclosure is set forth in the following claims.

1. A method of suggesting contact data, performed by a computing device, comprising:
retrieving suggested contact data associated with a contact entry;
associating a confidence level with the suggested contact data;
sending a request to display the suggested contact data;
receiving a confirmation indicative of one of an acceptance of the suggested contact data and a rejection of the suggested contact data; and
modifying the confidence level associated with the contact data in response to the confirmation received.

2. The method of claim 1, further comprising, if the confirmation is the acceptance, sending a request to supplement the contact entry with the suggested contact data.

3. The method of claim 1, wherein if the confirmation is the acceptance, the confidence level associated with the suggested contact data is modified by assigning an upvote to the confidence level.

4. The method of claim 1, wherein if the confirmation is the acceptance, the confidence level associated with the suggested contact data is modified by increasing a value corresponding to the confidence level.

5. The method of claim 4, wherein increasing the value corresponding to the confidence level comprises increasing the value by an acceptance multiplier.

6. The method of claim 1, wherein if the confirmation is the rejection, the confidence level associated with the suggested contact data is modified by decreasing a value corresponding to the confidence level, by a rejection multiplier.

7. The method of claim 5, further comprising:
storing the suggested contact data in a first database when the value of the modified confidence level is greater than a predetermined value, the first database comprising contact data and corresponding confidence levels indicative of a high reliability.

8. The method of claim 5, further comprising:
storing the suggested contact data in a second database when the value of the modified confidence level is less than a predetermined value, the second database comprising contact data and corresponding confidence levels indicative of a low reliability.

9. The method of claim 8, further comprising sending a request to expunge a second contact entry associated with the suggested contact data, the second contact entry being stored on a respective storage medium communicatively coupled to a second remote computing device if the modified confidence level is less than the predetermined value.

10. The method of claim 1, wherein if the confirmation is the rejection, modifying the confidence level associated with the suggested contact data comprises assigning a downvote to the confidence level.

11. The method of claim 1, wherein if the confirmation is the rejection, modifying the confidence level associated with the suggested contact data comprises decreasing a value corresponding to the confidence level.

12. The method of claim 1, wherein associating the confidence level comprises determining a value associated with the suggested contact data based at least in part on a credibility value of the remote data source.

13. The method of claim 1, wherein associating the confidence level is based at least in part on a secondary confirmation received from a secondary computing device.

14. The method of claim 13, wherein the confidence level is based at least in part on a plurality of secondary confirmations, each secondary confirmation received from one of a plurality of secondary computing devices.

15. The method of claim 1, wherein the confirmation causes a modification of the confidence level of the suggested contact data associated with a second contact entry of a second computing device.

16. The method of claim 1, further comprising sending instructions to prevent a display of the suggested contact data on a second computing device if the confirmation is the rejection.

17. The method of claim 1, wherein the suggested contact data is received from at least one remote data source.

18. The method of claim 17, wherein sending the request to display the suggested data comprises requesting displaying:
a plurality of suggested contact data;
a corresponding confidence level for each suggested contact data;
a user-selectable input for each suggested contact data, each user-selectable input including at least an accept option and a reject option; and
a source identifier representing the remote data source from which the suggested contact data was received.

19. The method of claim 18, wherein the source identifier is represented by a graphical icon, and if a detection of a cursor is received proximate to the graphical icon, the method further comprises sending a request to display a text box overlaying at least a portion of the prompt, the text box comprising an identification of the remote data source from which the associated suggested contact data was received.

20. A central computing device comprising:
a communication interface; and
a processor communicatively coupled with the communication interface and configured to:
retrieve from a remote data source, suggested contact data associated with a contact entry;
associate a confidence level associated with the suggested contact data;
send a request to display the suggested contact data;
receive a confirmation indicative of one of an acceptance of the suggested contact data and a rejection of the suggested contact data; and
modify the confidence level associated with the contact data in response to the confirmation received.

21. A remote computing device comprising:
a communication interface;
a display;
a storage medium having a contact entry stored thereon; and
a processor communicatively coupled with the communication interface, display, and storage medium, the processor configured to:
receive a suggested contact data that is associated with the contact entry and a confidence level indicative of a reliability of the suggested contact data;
execute instructions to present on the display, the suggested contact data and the confidence level;
receive a confirmation indicative of one of an acceptance of the suggested contact data and a rejection of the suggested contact data; and
transmit the confirmation.
